(19) United States
(12) Patent Application Publication
(10) Pub. No.: US 2006/0001922 A1
(43) Pub. Date: Jan. 5, 2006

(54) Method and system for multiple pass bidirectional scanning

(76) Inventor: Noah Jonathon Gawlik, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/883,430

(22) Filed: Jun. 30, 2004

(51) Int. Cl. H04N 1/46

(52) U.S. Cl. 358/505

(57) ABSTRACT

A method and system for creating color images representative of objects using contact image sensors. A first scanning pass is performed in a first direction using a first color of light and generating a first image data set from the first scanning pass. A second scanning pass is performed in a second direction, different from the first direction, utilizing a second color of light and generating a second image data set from the second scanning pass. The first image data set and the second image data set are combined to create a digital color representation of the object.

### TECHNICAL FIELD

The present invention relates generally to digital color scanning and imaging technology and, more particularly, to a method and system for creating digital color representations of objects using contact image sensors.

### BACKGROUND

Optical digital scanners generate digital images representative of the scanned objects or documents. A typical scanning system projects light onto the document to be scanned. A narrow band of light illuminates a portion of the document, generally known as a scan line, and the incident light is reflected onto one or more arrays of sensor elements. When the image of the portion of the document is reflected onto the array, the sensor elements generate image signal data representative of that portion of the document. The signal data is dependent on the intensity of the light reflected from the document onto the sensors. A scanning system may create a digital image of a document by sampling the signal data generated by the sensor elements while moving the scan line along the length of the document. The resulting digital image may be saved to an appropriate storage medium, such as a hard drive, a CD-ROM, a floppy disk or the like.

Typical scanning systems utilize either a charged coupled device (CCD) or contact image sensor (CIS) to generate signal data. In general, CCD type scanners include a light source and an optical system within a bar or carriage, known as the scan bar. The scan bar traverses the document generating signal data. In a CCD type scanner, light reflected from the object is focused through a series of lenses or mirrors that reduce the size of the image until it is focused onto a small CCD. In contrast, in a CIS type scanner, the CIS is generally contained within the scan bar alongside the light source. Light is reflected from the object onto the CIS without reduction. A CIS generally consists of a single linear array of individual sensor elements that extends the full width of the scanning surface of the scanning system. The number of sensors located on the array may be very dense; an array may contain more than 600 sensors per inch. While the sensors in the array are not actually in contact with the document being scanned, as implied by the name contact image sensor, they are in close proximity to the document. Generally, in a CIS scanner the document lays on a glass platen. A rod lens bridges the gap between the glass platen and the CIS and directs the light onto the CIS.

Color scanning systems typically generate multiple digital color component images of the scanned document. A color component image, also referred to as a color image data set, is a set of image data containing information regarding a single color. Typically, color scanners create red, green and blue component images. Color component images may be combined to generate a full color digital image representative of the document. Combining red, green and blue—the primary colors—in varying intensities can produce any of the colors that may be perceived by the human eye. The amounts of the primary colors required to match a particular color are known as the tristimulus values. A stimulus value is the amount of any single primary color. A color component image may contain the stimulus values for a single color, such as red. A scanning system may generate a full color digital image by combining stimulus values stored in multiple color component images.

While there are several different possible techniques for determining the tristimulus values necessary to represent the colors of the scanned object, CIS scanners typically use a multi-color light source to illuminate each scan line of the document successively with each of the primary colors. The primary color light reflects off the document onto the array of sensors. Accordingly, the signal data generated by the sensors is dependent solely on the intensity of that single primary color. This signal data corresponds to the stimulus value for that primary color. As the scanner illuminates each scan line with the primary colors, it stores the stimulus value generated by each color. When these stimulus values are correlated, the tristimulus values may be used to generate a full color digital image representative of the scanned document.

In a CIS type scanning system, the scan bar containing the CIS may perform a single scanning pass while sequentially illuminating the object. As used herein, a scanning pass refers to the movement of the scan bar relative to the document, during which stimulus values for at least one color are determined and used to create at least one color component image of the document. The scan bar may traverse the length of the document to create the image, or, alternatively, the document may be moved relative to a stationary scan bar. In a single pass scanning system, the scan bar containing the CIS typically traverses the document at a constant speed while the document is sequentially illuminated with primary color light (e.g., red, green and blue). Alternatively, the object may be illuminated with a white light while different colored filters are sequentially positioned between the document and the CIS or between the light source and the document. The signal data generated by the CIS are sampled as the document is illuminated with each primary color. The scanning system determines stimulus values corresponding to the signal data to create the color component images. Each set of tristimulus values represents one pixel, or picture element, of the full color digital image. The portion of the document that corresponds to a pixel is herein referred to as a pixel area. At the end of the scanning pass, the scan bar is returned to the initial position in preparation for scanning the next document.

Single pass scanning using sequential illumination is likely to generate color registration errors. In the method described above, each pixel area of the document is sequentially illuminated with the colors red, green and blue. Each pixel area is first illuminated with red light for a short period of time. During that period of time, the CIS is sampled to determine the stimulus value for the color red for that portion of the document. Next, that pixel area is illuminated with green light for the same amount of time. During this second period of time, the CIS is sampled to determine stimulus value for the color green for that portion of the document. However, the scan bar containing the CIS has traversed the pixel area at a constant velocity during the scanning pass and therefore, the image reflected onto the CIS will be from slightly different portions of the pixel area when the CIS is sampled to determine the red stimulus value and the green stimulus value for a single pixel. The resulting registration errors become apparent when the document being scanned transitions between colors within the pixel area. These color transitions may occur at slightly different times, as seen by the sensor, resulting in color registration errors.

Accordingly, there is a need for an improved method and system for color image scanning in CIS scanners to eliminate color registration errors inherent in the sequential illumination method of scanning objects. There is a further need for a method and system for color image scanning in CIS scanners that substantially eliminates the color registration errors without substantially increasing the time required to scan objects.

### SUMMARY OF THE INVENTION

The present invention provides a method and system for multiple pass scanning for generating a color image representative of an object. The method includes the steps of performing a first scanning pass over the object in a first direction with a contact image sensor utilizing a first color of light to generate a first color image data set, and a second scanning pass over the object in a second direction, different from the first direction, with the contact image sensor utilizing a second color of light to generate a second color image data set. A color image representative of the object is created by combining the first color image data set and the second color image data set. In an alternate embodiment of the invention, the method may include performing a third scanning pass over the object in the first direction with the contact image sensor utilizing a third color of light to generate a third color image data set. The third color image data set may be combined with the first color image data set and the second color image data set to create a color image representative of the object.

In addition, the invention provides a system for multiple pass scanning for generating a color image of an object. The system includes a contact image sensor, a light source and a processor. The processor is programmed to direct a first scanning pass over the object in a first direction utilizing a first color of light and generating a first color image data set from the first scanning pass. The processor is also programmed to direct a second scanning pass over the object in a second direction, different from the first direction, utilizing a second color of light and generating a second color image data set from the second scanning pass. The processor combines the color image data to form the scanned image and stores the image in a data storage device, such as on a disc. In an alternate embodiment of the invention, the processor is programmed to direct a third scanning pass over the object in the first direction utilizing a third color of light and generating a third color image data set from the third scanning pass. The third color image data set may be combined with first color image data set and the second color image data set to form the scanned image.

In one embodiment of the invention, the light source is mounted on a scan bar, which also supports the contact image sensor, and includes an array of light-emitting diodes (LEDs) capable of producing different colors of illumination, preferably red, green and blue. In another embodiment, the light source produces “white” light and the invention includes color filters that are placed either between the light source and the object to be scanned or the object and the contact image sensor. The color filters preferably produce red, green and blue light for successive scanning passes.

Other advantages will be apparent from the following description, the accompanying drawings and the appended claims.

### BRIEF DESCRIPTION OF THE DRAWINGS

FIG. 1 is a schematic representation of a scanning system according to an embodiment of the present invention.

FIG. 2 is a block diagram of the control unit of the scanning system of FIG. 1.

FIG. 3 is a schematic representation of a pixel area pattern scanned by a scanning system using the single pass sequential illumination method.

FIG. 4 is a schematic representation of a pixel area pattern scanned according to an embodiment of the present invention.

FIG. 5 is a flow chart of the scanning logic executed by the control unit of an embodiment of the present invention.

FIG. 6 is a flow chart of the scanning logic used in an alternate embodiment of the present invention.

### DETAILED DESCRIPTION

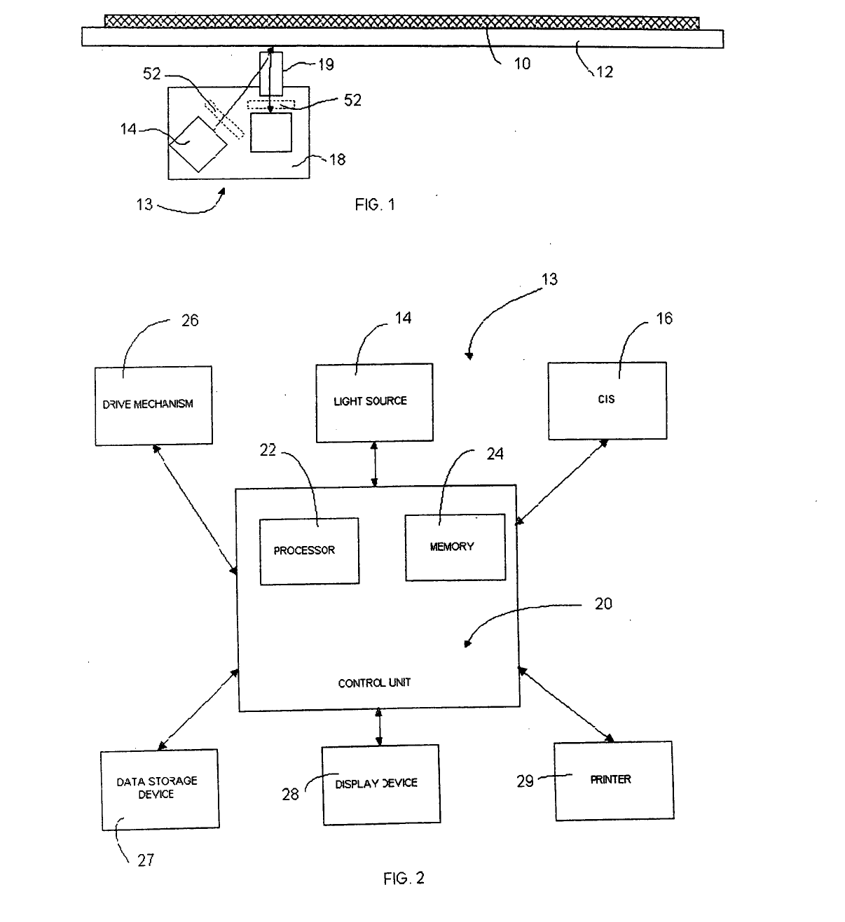

As shown in FIG. 1, a document 10 lying on a glass platen 12 is scanned by a scanning system 13 of the present invention that includes a light source 14 that illuminates the document 10. The light is reflected off the document 10 and onto a CIS 16. The CIS 16 generates signal data corresponding to the intensity of the image reflected from the document 10 onto the CIS 16. In a preferred embodiment, the CIS 16 and the light source 14 are contained within a scan bar 18, which traverses the length of the glass platen 12 during a scanning pass. The scan bar 18 also includes a rod lens 19 that bridges the gap between the CIS 16 and the glass platen 12 and directs light reflected from the object down onto the CIS 16.

Referring now to FIG. 2, in a preferred embodiment, the scanning system 13 includes a control unit 20 that regulates the operation of the scanning system. The control unit 20 includes a processor 22 or central processing unit (CPU) and a memory 24. The control unit 20 is connected to the light source 14 and the CIS 16. The processor 22 controls the illumination by the light source 14, including, in the case of a multi-color light source, the color of the light emitted by the light source 14. The processor 22 also controls the rate at which the signal data generated by the CIS 16 are sampled. The memory 24 is preferably dynamic memory, which may be updated and modified, such as dynamic random access memory (DRAM). Signal data generated by the CIS 16 is stored in memory 24 for processing.

The control unit 20 is also connected to a drive mechanism 26. In a preferred embodiment, the drive mechanism 26 controls the motion of the scan bar 18 containing the light source 14 and the CIS 16. The control unit may regulate the velocity at which the scan bar 18 traverses the document 10 during a scanning pass as well as the direction in which the scan bar traverses the document. In an alternate embodiment, the document 10 may be moved past a stationary scan bar 18, in which case the drive mechanism 26 may control the motion of the document 10. The control unit 20 is connected to a data storage device 27, such as long term memory including a hard disk, CD-ROM and the like, in which the color digital image may be stored. The control unit 20 may also be connected to a display device 28, such as a cathode ray tube (CRT) for displaying the digital color image, or a printer 29. The functions of the control unit may be broken down over several components and may be implemented by a combination of hardware, software and firmware. As used herein, firmware refers to memory chips, including, but not limited to, flash memory or EEPROMs (electronically erasable programmable read only memory), which hold their content without electric power.

In a preferred embodiment, the light source 14 is capable of emitting multiple colors of light. The light source 14 may be implemented by a light emitting diode (LED) array capable of producing different colors of illumination, such as red, green and blue. The LED array may include a plurality of separate LEDs of each of color spanning the width of the glass platen 12 to illuminate the document. The separate LEDs are connected such that all the LEDs for a given color may be illuminated simultaneously, projecting a single color of light onto the document 10. In an alternate embodiment, the light source 14 may include only a single LED of each of the different colors. The light from each individual LED may be spread over the surface of the document 10 by a light pipe. As used herein, a light pipe is generally a molded piece of plastic, capable of distributing the light generated by an LED over a portion of the document 10.

In an alternate embodiment, the scanning system may include a white light source, such as an incandescent or fluorescent light and a set of colored filters. Each of the filters may be individually positioned between the document 10 and the CIS 16, such that the CIS receives only light of a predetermined color. For example, during a first period of time a first filter may be positioned between the document 10 and the CIS 16, such that the CIS 16 receives only light of a first predetermined color (e.g., red). During a second period of time a second filter may be positioned between the document 10 and the CIS 16, such that the CIS 16 receives only green light. Finally, during a third period of time a third filter may be positioned between the document 10 and the CIS 16, such that the CIS 16 receives only blue light. Alternatively, the filters may be positioned between the light source 14 and the document 10. In this manner, filters may be utilized so as to produce the same effect as illuminating the document 10 with different color lights.

In a preferred embodiment, the scanning system described above utilizes a multiple pass scanning method to avoid the color registration problems inherent with single pass scanning. In multiple pass scanning, the scanning system performs multiple during which the document 10 is illuminated with a different colors. If the motion of the scan bar is repeatable with high precision, the stimulus values for each of the colors will be generated from the same location on the document, yielding highly accurate color registration. While in general scanners do not have perfectly repeatable scan bar motion, scanners are designed to have highly repeatable scan bar motion, such that the color registration errors caused by variations in scan bar motion may be less severe than those generated during single pass scanning.

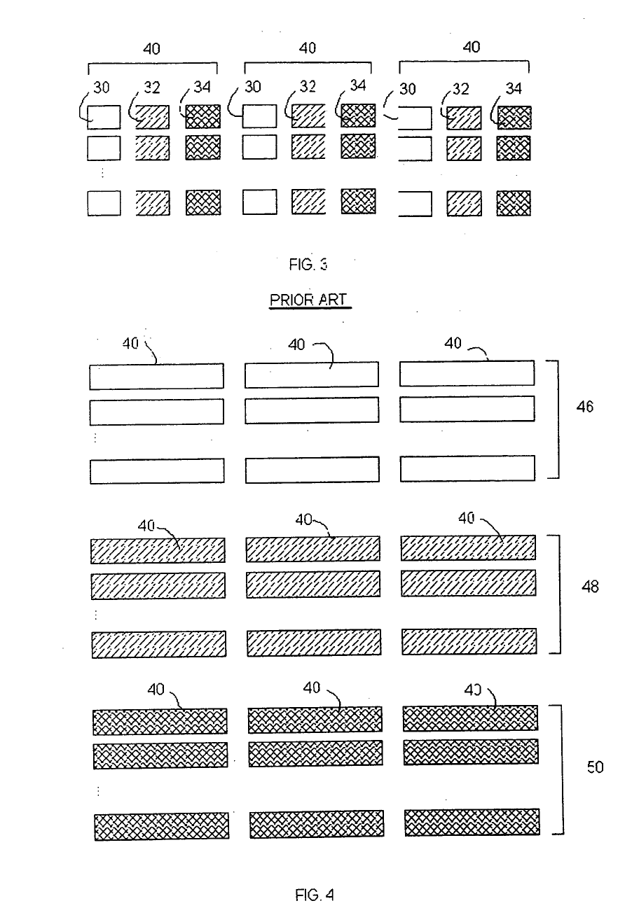

As illustrated in FIG. 3, conventional single pass scanning using sequential illumination results in color registration errors by definition. For example, in a scanning system using sequential red, blue and green illumination, only the first third 30 of the pixel area is received by the CIS 16 and utilized to generate the red stimulus value for the pixel. The first third 30 of the pixel area determines the intensity of red for the entire pixel. Similarly, the second third 32 of the pixel area determines the intensity of green for the entire pixel and the final third 34 of the pixel area determines the intensity of blue for the entire pixel. Each of the color stimulus values is determined based upon signal data generated from a slightly different location on the document 10. If the entire pixel area is one solid color, this method is entirely accurate. However, if there is a transition in color within the pixel area, color registration errors may occur.

If a document 10 were to transition between white and black, as occurs at the edge of text letters, the tristimulus values would be inconsistent. For example, if the transition from white to black occurs within the second third 32 of the pixel area, the red stimulus value will be inconsistent with the blue and green stimulus values. The red stimulus value is generated from the first third 30 of the pixel area, which is white in color. The green and blue stimulus values are generated from the second third of the pixel area and the final third of the pixel area, respectively, which is black in color. The resulting tristimulus values would have an extremely high red stimulus value and very low green and blue stimulus values, resulting in a halo of color at the edge of the black text.

Referring now to FIGS. 1 and 4, in a preferred embodiment of the present invention, the scanning system 13 performs multiple scanning passes, illuminating the document 10 with a different color of light during each scanning pass. For example, the scan bar 18 may perform a first scanning pass 46 while the document 10 is illuminated using red light, a second scanning pass 48 while the document 10 is illuminated with green light and a third scanning pass 50 while the scanning pass is illuminated with blue light. In contrast to the single pass scanning method discussed above, during the three scanning passes 46, 48 and 50 the CIS 16 will receive light reflected from the entire pixel area 40 to determine the intensity of the color component, rather than just one third of the pixel area. Using the multiple pass scanning method, the tristimulus values are all determined from signal data generated by light reflected from the same location on the document, thereby eliminating the registration errors inherent in the single pass scanning method described above.

Although the scan bar 18 traverses the document 10 multiple times in the multiple pass scanning method, the time required to scan a document 10 is not three times that of the single pass scanning method. Because the CIS 16 signal data are sampled only once as the scan bar 18 traverses each pixel area, rather than being sampled three times per pixel area as required in single pass scanning, the scan bar may traverse the document at three times the velocity of the single pass scanning method described above. Accordingly, each scanning pass may be performed in one third of the time. The main increase in scanning time to perform multiple pass scanning is due to the delay in scanning necessary to allow the scan bar 18 to return to its initial position before beginning subsequent scanning passes.

Scanning time in multiple pass scanning may be minimized using bidirectional scanning. Generally, scanning systems only collect data when the scan bar 18 is moving in the initial direction. When the scan bar 18 reaches the far end of the document 10, the scan bar 18 is returned to the beginning of the document 10, but no further data are collected during this return motion. In bidirectional scanning, when the scan bar 18 completes an initial scanning pass, the scan bar 18 reverses direction and continues to scan the document 10. The second scanning pass is performed while the scan bar 18 moving in a direction opposite the initial scanning direction. During this second or return scanning pass, while the scan bar 18 is moving in the opposite direction, the signal data are collected in reverse order relative to the order in which they were collected during the first scanning pass. However, the color component images may be correlated by the processor 22 (FIG. 2) to generate the full color digital image representation of the document 10. In a preferred embodiment, after the second scanning pass, the scanning system may reverse the direction of the scan bar and perform a third scanning pass in the initial direction. The scanning system may continue to perform scanning passes in alternating directions to generate the stimulus values for each color.

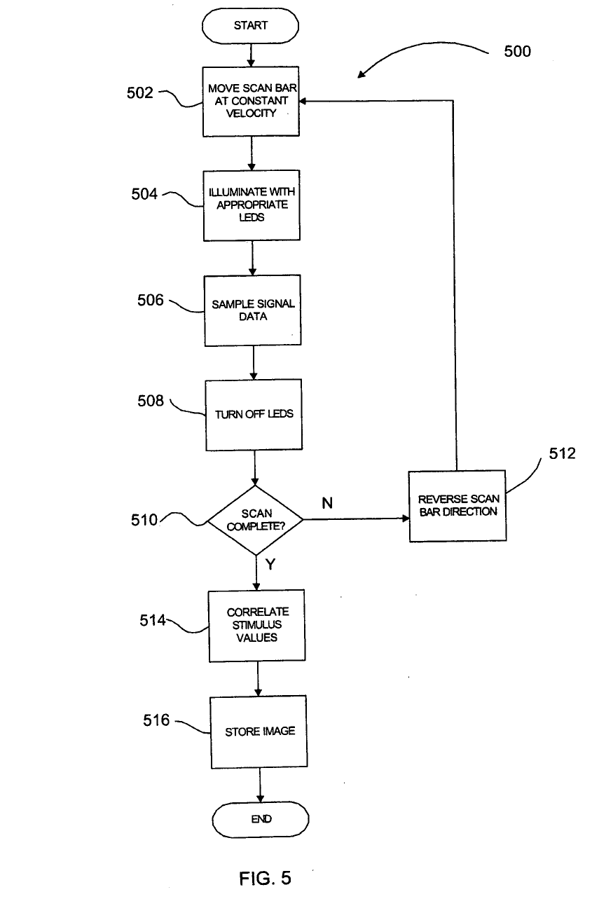

Referring now to FIG. 5, in a preferred embodiment, the control unit 20 (FIG. 1) directs the components of the scanning system to perform a process 500, stored in memory 24 to generate a full color image representation of a document 10. Beginning at step 502, the scan bar 18 (FIG. 1) begins traversing the document 10 at a constant velocity. In step 504, the appropriate LEDs of the scan bar 18 are illuminated to provide a single color of light. The signal data generated by the CIS 16 are sampled as the scan bar 18 moves along the document 10 in step 506. At step 508, once the scan bar 18 has made a complete pass across the document 10, all of the LEDs are turned off. At step 510, the processor 22 (FIG. 2) determines whether scanning of the document 10 is complete. If scanning is not complete, the scan bar 18 will reverse direction at step 512 and return to step 502 to perform another scanning pass in the opposite direction. In a preferred embodiment, the scanning system will perform three scanning passes in alternating directions. Once the scanning of the document 10 is complete, the processor 22 will correlate the stimulus values at step 514 and store the color digital image on a data storage device 27 at step 516.

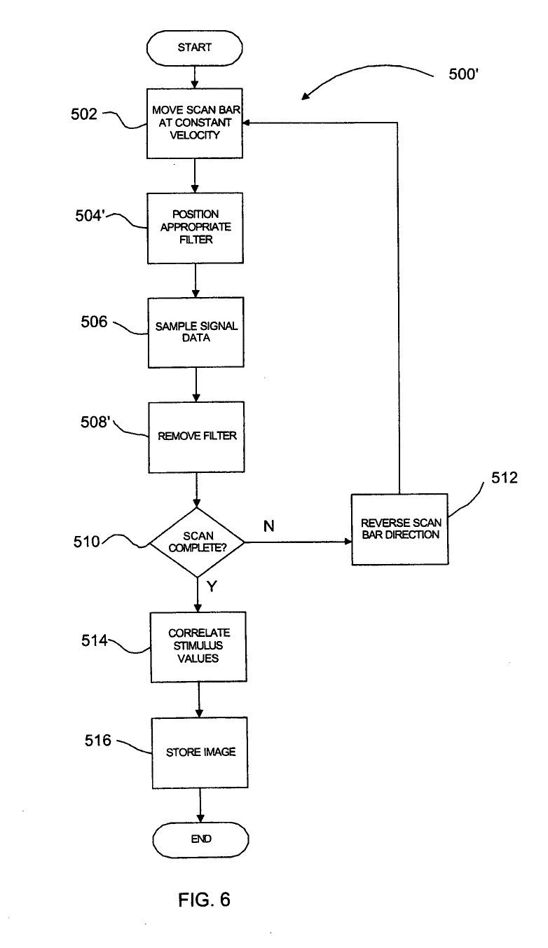

In an alternate embodiment shown in FIG. 6, the scanning system 13 may utilize a white light and a plurality of color filters instead of a multi-color light source. If the scanning system utilizes color filters, the process 500′ would include a step 504′ of positioning the appropriate filter 52 (shown in phantom in FIG. 1) either between the light source 14 and the document 10 or between the document 10 and the CIS 16, rather than turning on the appropriate LEDs. Similarly, step 508′ would consist of removing the filter from between the light source 14 and the document 10 or the document 10 and the CIS 16. While light received through color filters affects the CIS in the same manner as light generated by a colored light source, the use of filters would require the addition of an extra mechanical device (not shown) to manipulate the filters.

The foregoing description was directed to flatbed scanners, wherein the document 10 is placed onto a glass platen 12 and the scan bar 18 traverses the glass platen 12 while performing a scanning pass. However, the invention is not intended to be limited to such flatbed scanning systems. Multiple pass, bidirectional scanning may also be utilized in scanners where the document is moved relative to the scan bar, including scroll feed type scanners, in which a system of rollers moves the document past a stationary scan bar, and moving flat bed scanners, in which a document is placed on a glass platen and the platen and the document are moved relative to a the stationary scan bar.

While the embodiments described herein use three primary colors of light to generate a color digital image representative of the document, (i.e., red, green and blue), the invention is not limited either to the use of three colors of light or to red, green and blue light colors in particular. An alternate embodiment of the invention may utilize only two colors of light, or four or more colors of light.

The foregoing description of several methods and systems of the invention has been presented for the purposes of illustration. It is not intended to be exhaustive or to limit the invention to the precise procedures disclosed, and obviously many modifications and variations are possible in light of the above teaching. It is intended that the scope of the invention be defined by the claims appended hereto.

What is claimed is:

1. A method for multiple pass scanning for generating a color image of an object comprising the steps of:
performing a first scanning pass over said object in a first direction with a contact image sensor utilizing a first color of light and generating a first color image data set therefrom;
performing a second scanning pass over said object in a second direction different from said first direction with said contact image sensor utilizing a second color of light different from said first color of light and generating a second color image data set therefrom; and
combining said first color image data set and said second color image data set to generate said color image of said object.

2. The method of claim 1 wherein the first scanning pass step includes the step of moving at least one of said contact image sensor or said object in said first direction while illuminating said object, and receiving said first color of light reflected from the object onto the contact image sensor.

3. The method of claim 1 wherein the second scanning pass step includes the step of moving at least one of said contact image sensor or said object in said second direction while illuminating said object, and receiving said second color of light reflected from said object onto said contact image sensor.

4. The method of claim 1 wherein said first scanning pass step includes the steps of illuminating said object; moving at least one of said contact image sensor or said object in said first direction; receiving said first color of light reflected from said object onto said contact image sensor; and collecting said first color image data set from said contact image sensor.

5. The method of claim 1 wherein said second scanning pass step includes the steps of illuminating said object; moving at least one of said contact image sensor or said object in said second direction; receiving said second color of light reflected from said object onto said contact image sensor; and collecting said second color image data set from said contact image sensor.

6. The method of claim 1 wherein said step of combining said first color image data set and said second color image data set includes the step of correlating said first color image data set and said second color image data set.

7. The method of claim 1 further comprising the step of performing a third scanning pass over said object in said first direction with said contact image sensor utilizing a third color of light different from said first color of light and said second color of light and generating a third color image data set therefrom; and
wherein the combining step includes the step of combining said third color image data set to said first color image data set and said second color image data set to generate said color image of said object.

8. The method of claim 7 wherein the third scanning pass step includes the step of moving at least one of said contact image sensor or said object in said first direction while illuminating said object, and receiving said third color of light reflected from said object onto said contact image sensor.

9. The method of claim 7 wherein said step of combining said first color image data set, said second color image data set and said third color image data set includes the step of correlating said first color image data set, said second color image data set and third color image data set.

10. The method of claim 7 wherein said third scanning pass step includes the steps of illuminating said object; moving at least one of said contact image sensor or said object in said first direction; receiving said third color of light reflected from said object onto said contact image sensor; and collecting said third color image data set from said contact image sensor.

11. The method of claim 1 further comprising the step of illuminating said object with a plurality of different colors of light such that said object is illuminated with said first color of light during said first scanning pass and said object is illuminated with said second, different color of light during said second scanning pass.

12. The method of claim 11 wherein said illuminating step includes the step of illuminating said object with of a plurality of light emitting diodes.

13. The method of claim 11 wherein said illuminating step includes the step of illuminating said object with colors selected from the colors red, green and blue.

14. The method of claim 1 further comprising the steps of:
positioning a first filter from a plurality of color filters between one of said object and said contact image sensor or a light source and said object during said first scanning pass; and
positioning a second filter different from the first filter from said plurality of color filters between one of said object and said contact image sensor or said light source and said object during said second scanning pass.

15. The method of claim 14 wherein said positioning steps each include the step of positioning a filter selected from a red filter, a blue filter and a green filter, and said second filter is different from said first filter.

16. The method of claim 1 wherein said steps of performing first and second scanning passes includes utilizing said contact image sensor having a single, linear array of sensor elements.

17. A system for multiple pass scanning for generating a color image of an object, comprising:
a contact image sensor;
a light source; and
a processor;
wherein the processor is programmed to perform the steps of:
directing said contact image sensor to perform a first scanning pass over said object in a first direction utilizing a first color of light and generating a first color image data set therefrom; and
directing said contact image sensor to perform a second scanning pass over said object in a second direction, different from said first direction, utilizing a second color of light different from said first color of light and generating a second color image data set therefrom.

18. The system of claim 17 wherein the step of directing a first scanning pass includes the steps of:
controlling the illumination of said object by said light source;
directing the movement at least one of said contact image sensor or said object in said first direction;
collecting said first color image data set generated by receiving said first color of light reflected from said object onto said contact image sensor;
where the step of directing a second scanning pass includes the steps of:
controlling the illumination of said object by said light source;
directing the movement at least one of said contact image sensor or said object in said second direction; and
collecting said second color image data set generated by receiving the second color of light reflected from said object onto said contact image sensor.

19. The system of claim 17 further comprising the step of directing said contact image sensor to perform a third scanning pass over said object in a first direction utilizing a third color of light different from said first color of light and said second color of light and generating a third color image data set therefrom.

20. The system of claim 19 wherein the step of directing a third scanning pass includes the steps of controlling the illumination of the object by the light source, directing the movement at least one of said contact image sensor or said object in said first direction and collecting said third color image data set generated by receiving said first color of light reflected from the object onto said contact image sensor.

21. The system of claim 17 wherein the light source is configured to illuminate the object in a plurality of different colors.

22. The system of claim 21 wherein said plurality of different colors comprise red, green and blue.

23. The system of claim 17 wherein the light source is comprised of a plurality of light emitting diodes.

24. The system of claim 17 further comprising a plurality of filters movably positioned between one of said contact image sensor and said object or said light source and said object.
